(19) United States
(12) Patent Application Publication
(10) Pub. No.: US 2008/0008147 A1
(43) Pub. Date: Jan. 10, 2008

(54) WIRELESS STATION, WIRELESS COMMUNICATION SYSTEM, WIRELESS COMMUNICATION CONTROL METHOD, AND COMPUTER-READABLE MEDIUM

(75) Inventor: SATOSHI NAKAYAMA, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC CORPORATION, Tokyo (JP)

(21) Appl. No.: 11/774,342

(22) Filed: Jul. 6, 2007

(30) Foreign Application Priority Data
Jul. 7, 2006 (JP) 2006-188325

(51) Int. Cl. H04Q 7/24

(52) U.S. Cl. 370/338

(57) ABSTRACT

The present invention provides a wireless communication system that prevents radio interference between a wireless access point and a wireless device, even where the wireless access point cannot recognize the existence of the wireless device to be an interference source that causes radio interference with a radio wave from the wireless access point with which a wireless station is associated. The wireless communication system is formed with the wireless access point and the wireless station that is associated with the wireless access point and performs wireless communications. The wireless station detects a wireless device (a neighbor wireless access point) to be an interference source that causes radio interference with a radio wave from the associated wireless access point. The wireless station transmits a control signal for preventing radio interference to the wireless device to be an interference source. Upon receipt of the control signal from the wireless station, the wireless device to be an interference source performs a control operation so as to prevent radio interference.

This application is based upon and claims the benefit of priority from Japanese patent application No. 2006-188325, filed on Jul. 7, 2006, the disclosure of which is incorporated herein in its entirety by reference.

### BACKGROUND OF THE INVENTION

1. Field of the Invention

The present invention pertains to a wireless communication system formed with a wireless access point and a wireless station that is associated with the wireless access point and performs wireless communications, and more particularly, to a wireless station, a wireless communication system, a wireless communication control method, and a computer-readable medium having a wireless communication control program that prevent radio interference.

2. Description of the Related Art

A conventional wireless communication system, such as a wireless LAN, is designed to receive Internet services, with wireless stations being connected to a wired network via wireless access points.

In a conventional wireless communication system, carrier sensing is performed to detect another wireless device that is performing a wireless communication using a common frequency band, and interference is prevented by time-dividing the communication time between wireless stations and a wireless access point. However, since the amount of data in one unit time cannot be increased, the throughput of the entire system cannot be increased even if the number of wireless access points is increased. As a result, the throughput per a wireless access point becomes lower.

To solve the above problem, a document discloses a communication control method for preventing interference between data packets by performing communications simultaneously from access points to user terminals located in non-interference ranges, and performing time-division communications from the access points to user terminals located in interference ranges (see Japanese Patent Application Laid-Open No. 2004-260637 (document 1), for example).

Referring now to FIGS. 14 and 15, the communication control method disclosed in document 1 is described.

The communication control method disclosed in document 1 is utilized in a system formed with a management server 1, wireless access points AP₁ through AP_{N} (N being an integer), and at least one wireless station STA, as shown in FIG. 14. A control operation shown in FIG. 15 is performed in this system.

The management server 1 shown in FIG. 14 manages the received signal information (RSSI: Received Signal Strength Indicator) as to each of the wireless access points AP₁ through AP_{N}, and controls communications of the wireless access points AP₁ through AP_{N}. Each of the wireless access points AP₁ through AP_{N} performs wireless communications with the wireless station STA located within the communication range of the wireless access points AP₁ through AP_{N}. The wireless station STA is a terminal device that performs wireless communications, and is associated with one of the wireless access points AP₁ through AP_{N}. The wireless station STA performs wireless communications with the wireless access point AP₁ through AP_{N}.

In the wireless communication system shown in FIG. 14, each of the wireless access points AP₁ through AP_{N} is located outside the communication range of neighbor wireless access points AP₁ through AP_{N}, and cannot measure the received signal strength of neighbor wireless access points AP₁ through AP_{N}. The wireless station STA is located within the communication range of the wireless access points AP₁ and AP₂, and is associated with the wireless access point AP₁. The wireless access point AP₁ with which the wireless station STA is associated is referred to as the associated wireless access point, and the wireless access point AP₂ with which the wireless station STA is not associated is referred to as a neighbor wireless access point.

Referring now to FIG. 15, a series of procedures in a control operation to be performed in the wireless communication system shown in FIG. 14 is described.

First, each of the wireless access points AP₁ and AP₂ transmits a beacon signal to the wireless station STA located within the communication range of AP₁ and AP₂ (step S1).

Based on the beacon signals received from AP₁ and AP₂, the wireless station STA measures the received signal strength indicator (RSSI) of each of the beacon signals of AP₁ and AP₂ (step S2). The wireless station STA then transmits the information as to the measured received signal strengths (the received signal information) of AP₁ and AP₂ to the management server 1 (step S3). Accordingly, the management server 1 can manage the received signal information as to the AP₁ and AP₂ (step S4).

Based on the received signal information received from the wireless station STA, the management server 1 determines whether the wireless station STA is located within an interference range or within a non-interference range (step S5).

An interference range is a range in which radio interference is caused when the associated wireless access point AP₁ and the neighbor wireless access point AP₂ simultaneously perform data transmission to the wireless station STA. A non-interference range is a range in which no radio interference is caused even when the associated wireless access point AP₁ and the neighbor wireless access point AP₂ simultaneously perform data transmission to the wireless station STA. In FIG. 14, the wireless station STA is located in the common communication range of the associated wireless access point AP₁ and the neighbor wireless access point AP₂. When the associated wireless access point AP₁ and the neighbor wireless access point AP₂ simultaneously perform data transmission to the wireless station STA in this system, radio interference is caused. Therefore, the wireless station STA is located in an interference range.

If the wireless station STA is determined to be located in a non-interference range in accordance with the received signal information received from the wireless station STA, the management server 1 transmits a control signal (a control signal for allowing simultaneous transmission) to notify the associated wireless access point AP₁ and the neighbor wireless access point AP₂ that simultaneous data transmission can be performed (step S6).

If the wireless station STA is determined to be located in an interference range in accordance with the received signal information received from the wireless station STA, the management server 1 transmits a control signal (a control signal for prohibiting simultaneous transmission) to notify the associated wireless access point AP₁ and the neighbor wireless access point AP₂ that simultaneous data transmission should not be performed (step S6). Since the wireless station STA is located in an interference range in FIG. 14, the management server 1 transmits the control signal (the control signal for prohibiting simultaneous transmission) to notify the associated wireless access point AP₁ and the neighbor wireless access point AP₂ that simultaneous data transmission should not be performed. Accordingly, the associated wireless access point AP₁ and the neighbor wireless access point AP₂ that have received the control signal from the management server 1 do not perform transmission at the same time. Instead, time-division data transmission is performed, so that data transmission from the associated wireless access point AP₁ and data transmission from the neighbor wireless access point AP₂ do not overlap.

As described above, by the communication control method disclosed in document 1, the management server 1 manages the received signal information as to the wireless access points AP₁ and AP₂. Based on the received signal information as to AP₁ and AP₂, the management server 1 determines whether the wireless station STA is located in an interference range. If the wireless station STA is determined to be located in an interference range, the management server 1 performs a control operation so as not to allow simultaneous transmission from AP₁ and AP₂. Accordingly, AP₁ and AP₂ do not simultaneously perform data transmission to the wireless station STA, but performs time-division data transmission. Thus, a data collision between the wireless access points AP₁ and AP₂ can be prevented.

By the communication control method disclosed in document 1, however, all the wireless access points AP₁ through AP_{N} in the wireless communication system need to be connected to the same network, and the management server 1 needs to manage the received signal information as to all the wireless access points AP₁ through AP_{N}.

For example, when a wireless device 2 having the received signal information that cannot be managed by the managing server 1 exists in the wireless communication system, as shown in FIG. 16, the management server 1 cannot perform an interference prevention control operation for preventing radio interference between the wireless device 2 and the wireless access point AP₁ adjacent to the wireless device 2, and radio interference may be caused between the wireless device 2 and the wireless access point AP₁. When the associated wireless access point AP₁ performs data transmission to the wireless station STA at the same time as data transmission from the wireless device 2, a data collision occurs between the associated wireless access point AP₁ and the wireless device 2, and data retransmission is required.

Therefore, when there is the wireless device 2 to be an interference source that causes radio interference with a radio wave from the associated wireless access point AP₁ with which the wireless station STA is associated, it is necessary to utilize a control method for preventing radio interference between the associated wireless access point AP₁ and the wireless device 2 even when the associated wireless access point AP₁ cannot recognize the existence of the wireless device 2.

A reference document as a technical document filed earlier than the filing of the present invention discloses a wireless access method for performing communications, with a wireless channel being shared by wireless access points and wireless mobile terminals. Upon receipt of an instruction beacon for setting a non-collision period from one of the wireless access points, each of the wireless mobile terminals transmits a prohibited period set frame to the other wireless access points. When the wireless mobile terminal receives a beacon indicating an end of the non-collision period from the one wireless access point, the wireless mobile terminal transmits a prohibited period ending frame to the other wireless access points. In this manner, a frame collision can be prevented (see JP-A No. 2003-8587 (document 2), for example).

Another document discloses a mobile communication system in which a mobile station detects the intensity and frequency of interference waves with respect to a received signal from a base station, and either switches frequency channels or stops transmission when the detected result indicates a value exceeding a predetermined threshold level. In this manner, the congestion in the vicinities of cell boundaries can be reduced (see JP-A No. 2003-259414 (document 3), for example).

Yet another document discloses an access point intervention device that includes a control unit that allows one of two access points to perform communications, and forces the other access point to stand by, where interference is caused between the two access point using communication channels in the same frequency bands in a communication network that includes at least the two access points performing data transmission and reception with communication terminals through the predetermined communication channels (see JP-A No. 2004-48356 (document 4), for example).

Another document discloses a communication method for making the other access point devices communicable via a station device, without interference with any other communication, even where a subject access point device has an error and cannot perform communications (see JP-A No. 2003-304253 (document 5), for example).

Yet another document discloses a wireless communication device that realizes a suitable ad-hoc network without interference between communication stations in a communication environment where a channel is to be selected from channels and there is a plurality of channels, based on channel interference information at a peripheral station (see JP-A No. 2005-86408 (document 6), for example).

However, documents 2 to 6 do not teach any measures to prevent radio interference between the wireless access point AP₁ and the wireless device 2 even when the wireless access point AP₁ cannot recognize the existence of the wireless device 2 that is an interference source to cause radio interference with a radio wave from the wireless access point AP₁ with which the wireless station STA is associated.

### SUMMARY OF THE INVENTION

An exemplary object of the invention is to provide to provide a wireless station, a wireless communication system, a wireless communication control method, and a computer-readable medium having a wireless communication control program that prevent radio interference between a wireless access point AP₁ and a wireless device 2, even where the wireless access point AP₁ cannot recognize the existence of the wireless device 2 to be an interference source that causes radio interference with a radio wave from the wireless access point AP₁ with which the wireless station STA is associated.

A wireless station according to an exemplary aspect of the invention is associated with a wireless access point, and performs wireless communications with the wireless access point. The wireless station includes: an interference source detecting unit that detects a wireless device to be an interference source that causes radio interference with a radio wave from the wireless access point; and a control signal transmitting unit that transmits a control signal for preventing radio interference to the wireless device to be an interference source.

A wireless communication system according to an exemplary aspect of the invention includes a wireless access point and a wireless station that is associated with the wireless access point and performs wireless communication. The wireless station includes: an interference source detecting unit that detects a wireless device to be an interference source that causes radio interference with a radio wave from the wireless access point; and a control signal transmitting unit that transmits a control signal for preventing radio interference to the wireless device to be an interference source.

A communication control method according to an exemplary aspect of the invention is utilized in a wireless station that is associated with a wireless access point and performs wireless communications with the wireless access point. The method includes: the step of detecting a wireless device to be an interference source that causes radio interference with a radio wave from the wireless access point, and the step of transmitting a control signal for preventing radio interference to the wireless device to be an interference source.

A computer-readable medium according to an exemplary aspect of the invention stores a communication control program executable at a wireless station that is associated with a wireless access point and performs wireless communications with the wireless access point. The communication control program is executed to perform an interference source detecting operation for detecting a wireless device to be an interference source that causes radio interference with a radio wave from the wireless access point, and a control signal transmitting operation for transmitting a control signal to the wireless device to be an interference source, the control signal being for preventing radio interference.

### BRIEF DESCRIPTION OF THE DRAWINGS

Features of the disclosed embodiments will be described by way of the following detailed description with reference to the accompanying drawings in which:

FIG. 1 illustrates the structure of a wireless communication system;

FIG. 2 shows the inner structure of each of the wireless access points AP1 and AP2 of the wireless communication system;

FIG. 3 is a flowchart of a series of operations to be performed by the communication unit 101 of each of the wireless access points AP1 and AP2 of a wireless communication system (at the time of data transmission);

FIG. 4 is a flowchart of a series of operations to be performed by the communication unit 101 of each of the wireless access points AP1 and AP2 of a wireless communication system (at the time of data reception);

FIG. 5 shows the inner structure of a wireless station STA of the wireless communication system;

FIG. 6 shows an example structure of an interference management table 208 stored in the memory unit 203 of the wireless station STA of the wireless communication system;

FIG. 7 is a flowchart of a series of operations to be performed by the communication unit 201 of the wireless station STA of the wireless communication system (at the time of data reception);

FIG. 8 is a flowchart of a series of operations to be performed by the control unit 202 of the wireless station STA of the wireless communication system (at the time of data reception);

FIG. 9 shows environmental conditions for a series of operations to be performed in a wireless communication system;

FIG. 10 is a sequence chart showing a series of operations to be performed by the wireless communication system;

FIG. 11 shows an example structure of the interference management table 208 stored in the memory unit 203 of a wireless station STA of a wireless communication system;

FIG. 12 is a flowchart showing a series of operations to be performed by the control unit 202 of the wireless station STA of the wireless communication system (at the time of data reception);

FIG. 13 shows an example structure of the interference management table 208 stored in the memory unit 203 of the wireless station STA of the wireless communication system;

FIG. 14 illustrates the structure of a conventional wireless communication system;

FIG. 15 is a sequence chart showing a series of operations to be performed in the conventional wireless communication system; and

FIG. 16 illustrates the problems with the conventional wireless communication system.

### DESCRIPTION OF EXEMPLARY EMBODIMENTS

First, the characteristics of a wireless communication system are described.

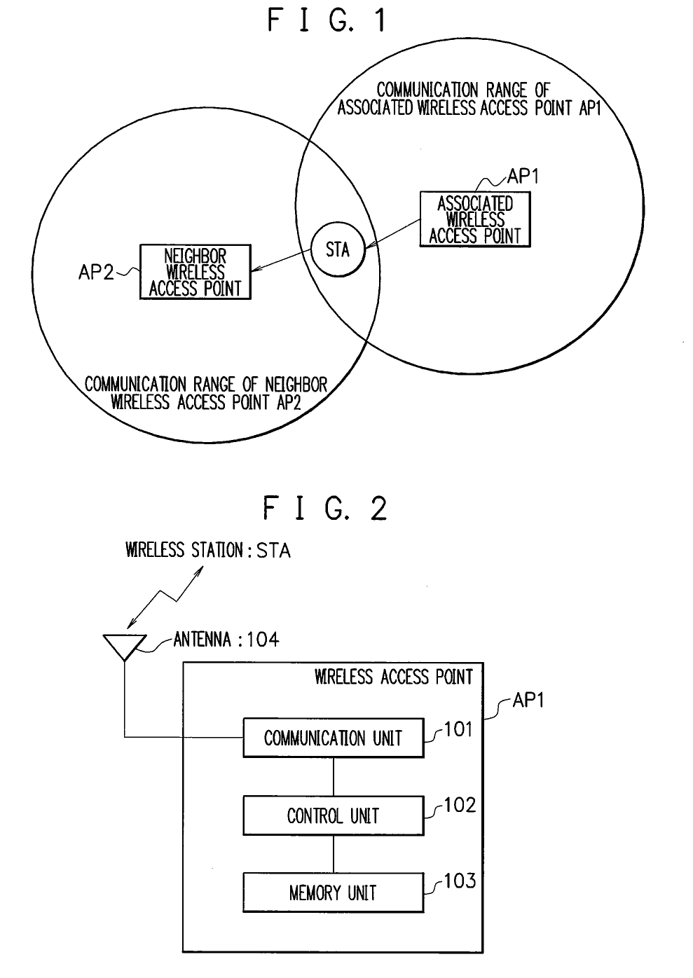

As shown in FIG. 1, the wireless communication system is a wireless communication system that includes a wireless access point ( ) AP1 and a wireless station STA that is associated with a wireless access point AP₁ and performs wireless communications. Since the wireless station STA is associated with the wireless access point AP₁, the wireless access point AP₁ is referred to as a associated wireless access point. A wireless access point AP₂ that is located near the wireless station STA is referred to as a neighbor wireless access point.

As shown in FIG. 1, the wireless station STA is located within the range in which radio waves from both the associated wireless access point AP₁ and the neighbor wireless access point AP₂ can be received. Meanwhile, the associated wireless access point AP₁ and the neighbor wireless access point AP₂ are located outside the range in which radio waves from each other can be received. The associated wireless access point AP₁ and the neighbor wireless access point AP₂ cannot directly recognize the existence of each other.

With this arrangement, when there is an overlapping portion between data transmission from the associated wireless access point AP₁ to the wireless station STA and data transmission from the neighbor wireless access point AP₂ to be interference sources to another wireless station (not shown), radio interference is caused by the radio wave transmitted from the associated wireless access point AP₁ and the radio wave transmitted from the neighbor wireless access point AP₂, and the wireless station STA located within the range in which radio waves from the associated wireless access point AP₁ and the neighbor wireless access point AP₂ can be received might not be able to receive the data from the associated wireless access point AP₁.

Therefore, the wireless station STA detects the wireless device (which is the neighbor wireless access point AP₂) that is the cause of the radio interference with the radio waves of the associated wireless access point AP₁, and transmits a control signal for preventing generation of radio interference to the wireless device AP₂ as the cause of interference. In this manner, the wireless device AP₂ as the cause of interference receives the control signal transmitted from the wireless station STA, and then performs a control operation to prevent radio interference.

Even where the associated wireless access point AP₁ and the wireless device AP₂ are located outside the range in which the radio waves from each other can be received, and the associated wireless access point AP₁ cannot recognize the existence of the wireless device AP₂ as the cause of interference, the wireless station STA controls the wireless device AP₂ as the cause of interference, so that radio interference between the associated wireless access point AP₁ and the wireless device AP₂ can be prevented. The following is a detail description of wireless communication systems with reference to the accompanying drawings.

### First Exemplary Embodiment

Referring to FIG. 1, a wireless communication system in accordance with a first exemplary embodiment is described.

As shown in FIG. 1, the wireless communication system includes a wireless station STA and wireless access points AP₁ and AP₂.

Each of the wireless access points AP₁ and AP₂ that form the wireless communication system is located outside the range in which radio waves from neighbor wireless access points can be received. Accordingly, AP₁ and AP₂ cannot recognize the existence of neighbor access point AP₁ or AP₂. The wireless station STA is located within the range in which radio waves from AP₁ and AP₂ are received, and the wireless station STA is associated with the wireless access point AP₁. The wireless access point AP₁ with which the wireless station STA is associated is referred to as the associated wireless access point, and the wireless access point AP₂ with which the wireless station STA is not associated is referred to as the neighbor wireless access point.

### <Inner Structures of Wireless Access Points AP₁, AP₂>

Referring now to FIG. 2, the inner structures of the wireless access points AP₁ and AP₂ of the wireless communication system are described. Since AP₁ and AP₂ are designed to have the same functions as each other, only the wireless access point AP₁ is explained in the following.

As shown in FIG. 2, the wireless access point AP₁ includes a communication unit 101, a control unit 102, a memory unit 103, and an antenna 104.

The communication unit 101 establishes a wireless channel to the wireless station STA via the antenna 104, and performs information transmission and reception at given frequencies. The communication unit 101 can also perform information transmission and reception to and from the other wireless access point AP₂. Since the wireless access point AP₁ is located outside the range in which radio waves from the wireless access point AP₂ are received, as shown in FIG. 1, the wireless access point AP₁ do not directly recognize the existence of the wireless access point AP₂.

The control unit 102 collectively controls the wireless access point AP₁. The memory unit 103 stores various set values for the wireless access point AP₁, and temporarily stores information to be transmitted or received via the communication unit 101. The various set values to be stored in the memory unit 103 include a carrier sense level to be used as the criterion for determining whether there is a wireless device that is transmitting radio waves, wireless channels, service set identifiers (SSID), and interference prevention determining information to be used as the criterion for determining whether current transmission data requires interference prevention measures. The interference prevention determining information includes the type (such as real-time communication or non-real-time communication) of the current transmission data, and the priority of the current transmission data (such as a priority to prevent data retransmission).

### (Series of Procedures in Operations by Communication Unit 101)

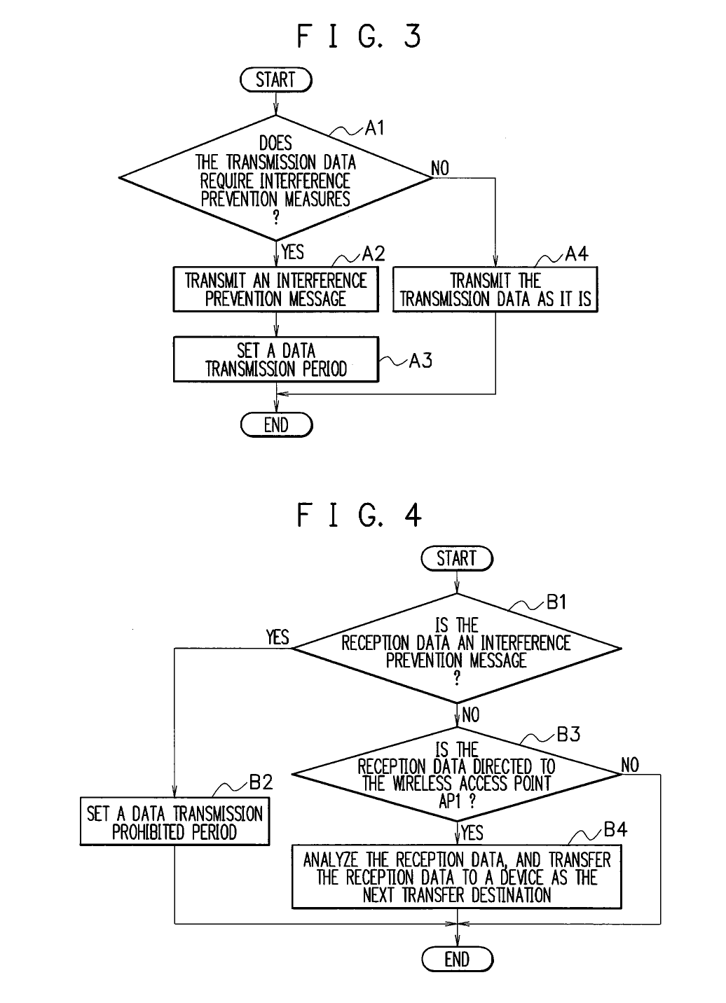

Referring now to FIGS. 3 and 4, operations to be performed by the communication unit 101 of the wireless access point AP₁ are described.

First, an operation to be performed by the communication unit 101 at the time of data transmission is described with reference to FIG. 3.

When transmitting transmission data, the communication unit 101 first determines whether the transmission data requires interference prevention measures, based on the interference prevention determining information stored in the memory unit 103 (step A1). If the transmission data is of a real-time communication, for example, the communication unit 101 determines that the transmission data requires interference prevention measures. If the transmission data is of a non-real-time communication, the communication unit 101 determines that the transmission data does not require interference prevention measures. The interference prevention determining information stored in the memory unit 103 is arbitrarily modified, and the communication unit 101 determines whether the current transmission data requires interference prevention measures, based on the interference prevention determining information currently stored in the memory unit 103.

If the communication unit 101 determines that the transmission data requires interference prevention measures based on the interference prevention determining information stored in the memory unit 103 (“Yes” in step A1), the communication unit 101 generates interference prevention message data that includes the data transmission period of the transmission data, and transmits the generated interference prevention message data (step A2). The communication unit 101 then sets the data transmission period in which the transmission data is to be transmitted in the memory unit 103 (step A3), and ends the operation.

When determining that it has reached the data transmission period set in the memory unit 103, the communication unit 101 transmits the transmission data. If the communication unit 101 determines that the transmission data does not require interference prevention measures in step A1 (“No” in step A1), the communication unit 101 does not perform an interference preventing operation, and transmits the transmission data as such (step A4).

Referring now to FIG. 4, an operation to be performed by the communication unit 101 at the time of data reception is described.

First, the communication unit 101 determines whether reception data received through the antenna 104 is an interference prevention message (step B1).

If the reception data received through the antenna 104 is determined to be an interference prevention message (“Yes” in step B1), the communication unit 101 sets the data transmission period contained in the interference prevention message as a data transmission prohibited period in the memory unit 103 (step B2). By doing so, the wireless access point AP1 is controlled so as not to perform data transmission during the data transmission prevented period set in the memory unit 103.

If the reception data received through the antenna 104 is determined not to be an interference prevention message but to be regular reception data (“No” in step B1), the communication unit 101 analyzes the reception data, and determines whether the reception data is directed to the wireless access point AP₁ (step B3). If the reception data is determined to be directed to the wireless access point AP₁ (“Yes” in step B3), the communication unit 101 identifies a device that is to be the next transfer destination, based on the transfer destination address contained in the reception data, and transfers the reception data to the transfer destination device (step B4). When the communication unit 101 determines whether the reception data is directed to the wireless access point AP₁, the communication unit 101 may determine whether the device address contained in the reception data is the address of the wireless access point AP₁, for example.

If the reception data is determined not to be directed to the wireless access point AP₁ (“No” in step B3), the communication unit 101 does not analyze the reception data, and ends the operation.

### <Inner Structure of Wireless Station STA>

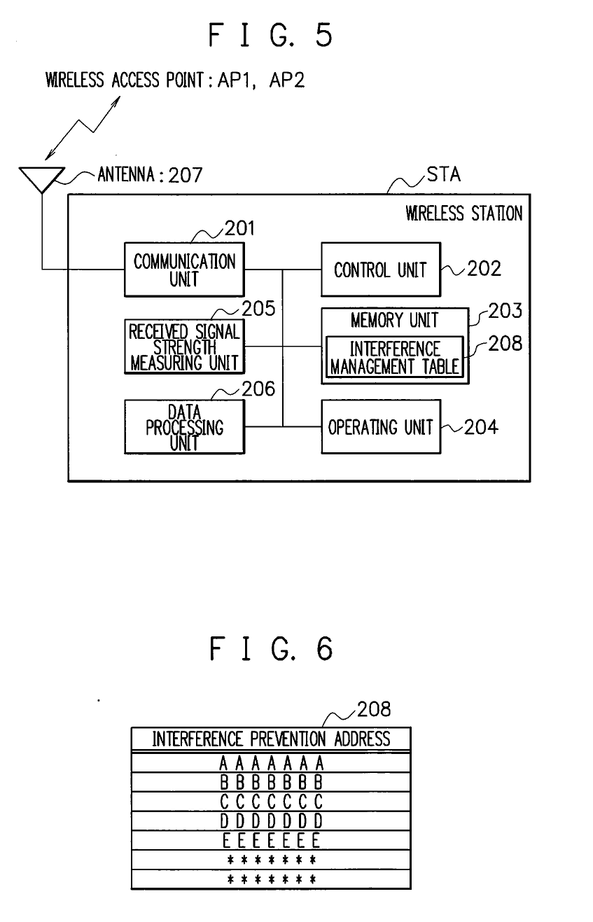

Referring now to FIG. 5, the inner structure of the wireless station STA of the wireless communication system is described.

As shown in FIG. 5, the wireless station STA includes a communication unit 201, a control unit 202, a memory unit 203, an operating unit 204, a received signal strength measuring unit 205, a data processing unit 206, and an antenna 207.

The communication unit 201 establishes a wireless channel to the wireless access point AP₁ via the antenna 207, and performs information transmission and reception at given frequencies.

The control unit 202 collectively controls the inside of the wireless station STA.

The memory unit 203 stores various set values for the wireless station STA, and temporarily stores information to be transmitted or received via the communication unit 201. The various set values to be stored in the memory unit 203 include a carrier sense level to be used as the criterion for determining whether there is a wireless device that is transmitting radio waves, the threshold value of a received signal strength indicator (RSSI) to be used as the operation standard for determining whether to carry out a handover process, wireless channels, and service set identifiers (SSID).

The memory unit 203 also stores an interference management table 208 that manages the addresses of wireless devices that cause radio interference with radio waves from the wireless access point AP₁ with which the wireless station STA is associated. FIG. 6 shows the table structure of the interference management table 208. As shown in FIG. 6, an interference management table 208 stores and manages the addresses (interference prevention addresses) of wireless devices that are interference sources to be subjected to radio interference prevention control. With this arrangement, upon receipt of an interference prevention message from the associated wireless access point AP₁, the wireless station STA transfers the interference prevention message received from the associated wireless access point AP₁ to the wireless devices having their addresses (interference prevention addresses) managed in the table 208.

The operating unit 204 inputs information for setting the various set values to be stored in the memory unit 203, and inputs command information for performing various control operations in the wireless station STA. The various set values include a carrier sense level to be used as the criterion for determining whether there is a wireless device that is transmitting radio waves, the threshold value of a received signal strength indicator (RSSI) to be used as the operation standard for determining whether to carry out a handover process, wireless channels, and service set identifiers (SSID).

The unit 205 measures the received signal strength indicator (RSSI) of the reception data received through the antenna 207.

The unit 206 performs data processing on reception data received by the wireless station STA and transmission data to be transmitted from the wireless station STA.

### (Series of Procedures to be Performed by Communication unit 201)

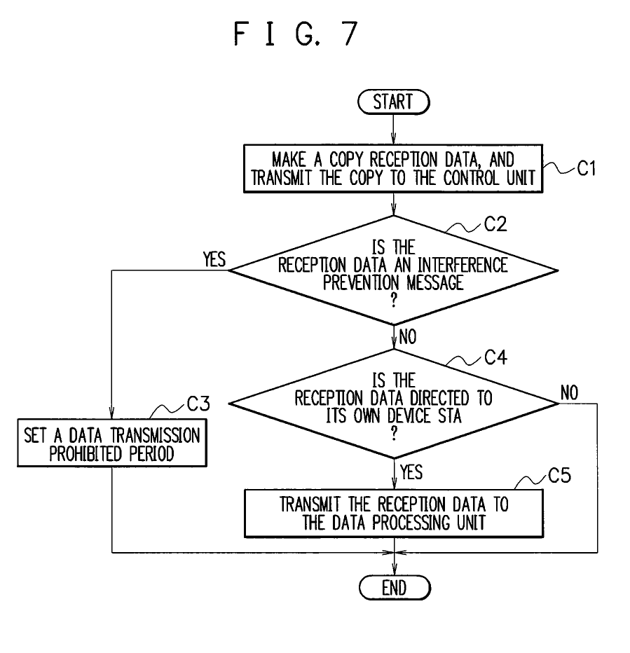

Referring now to FIG. 7, operations to be performed by the communication unit 201 of the wireless station STA is described.

First, the communication unit 201 makes a copy of reception data received through the antenna 207, and transmits the copy of the reception data to the control unit 202 (step C1). The communication unit 201 then determines whether the reception data received through the antenna 207 is an interference prevention message (step C2).

If the communication unit 201 determines that the reception data received through the antenna 207 is an interference prevention message (“Yes” in step C2), the communication unit 201 sets the data transmission period contained in the interference prevention message as a data transmission prohibited period in the memory unit 203 (step C3). By doing so, the wireless station STA controls data transmission, so that data transmission is not performed in the data transmission prohibited period set in the memory unit 203.

If the communication unit 201 determines that the reception data received through the antenna 207 is not an interference prevention message but regular reception data (“No” in step C2), the communication unit 201 analyzes the reception data, and determines whether the reception data is directed to the wireless station STA (step C4). If the reception data is determined to be directed to the wireless station STA (“Yes” in step C4), the communication unit 201 transmits the reception data to the data processing unit 206, which then performs data processing (step C5).

If the communication unit 201 determines that the reception data is not directed to the wireless station STA (“No” in step C4), the communication unit 201 does not transmit the reception data to the data processing unit 206, and ends the operation.

### (Series of Procedures to be Performed by Control Unit 202)

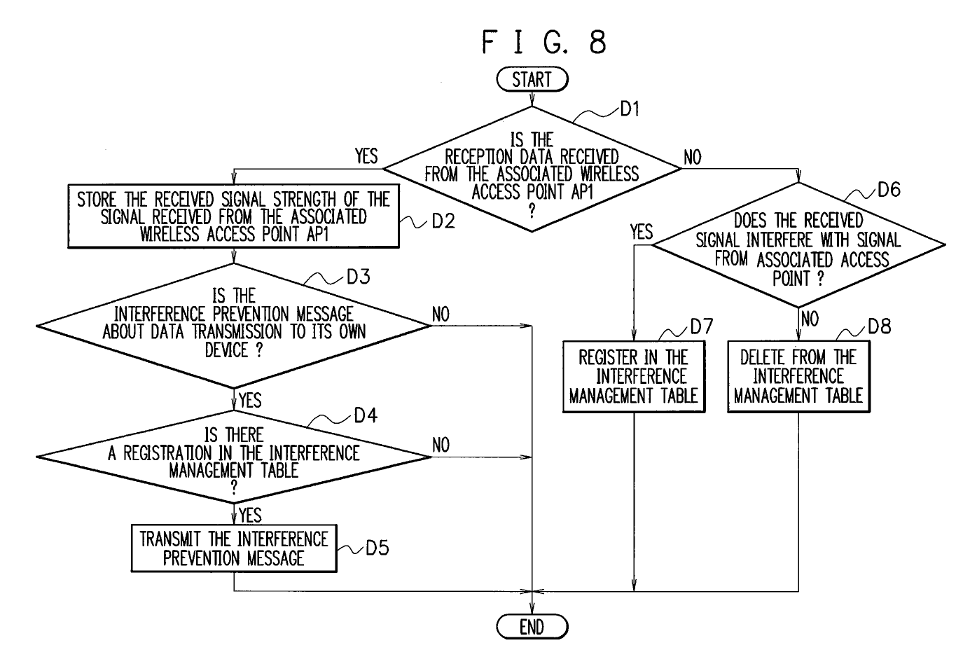

Referring now to FIG. 8, an operation to be performed by the control unit 202 is described.

First, the control unit 202 determines whether the reception data received from the communication unit 201 is reception data from the associated wireless access point AP₁ (step D1).

If the control unit 202 determines that the reception data received from the communication unit 201 is the reception data from the associated wireless access point AP₁ (“Yes” in step D1), the control unit 202 stores the result of measurement of a received signal strength indicator (RSSI) measured by the unit 205 into the memory unit 203 (step D2). By doing so, the wireless station STA can manage the latest received signal strength received from the associated wireless access point AP₁ in the memory unit 203.

The control unit 202 then determines whether the reception data received from the associated wireless access point AP₁ is an interference prevention message about data transmission to the wireless station STA (step D3). If the reception data received from the associated wireless access point AP₁ is determined to be an interference prevention message about data transmission to the wireless station STA (“Yes” in step D3), the control unit 202 performs an interference prevention control operation for a wireless device to be the interference source.

The control unit 202 determines whether there is a wireless device that is one of the interference sources registered in the table 208 in the memory unit 203 (step D4). If the control unit 202 determines that there is a wireless device that is one of the interference sources registered in the table 208 (“Yes” in step D4), the control unit 202 transfers the interference prevention message received from the associated wireless access point AP₁ to the wireless device registered in the table 208 on a multicast (step D5).

In this manner, the wireless device registered in the table 208 receives the interference prevention message from the wireless station STA. Upon receipt of the interference prevention message, the wireless device to be an interference source sets the data transmission period contained in the interference prevention message as a data transmission prohibited period, and is controlled so as not to perform data transmission in the data transmission prohibited period.

If the control unit 202 determines that the reception data received from the associated wireless access point AP₁ is not an interference prevention message about data transmission to the wireless station STA (“No” in step D3), the control unit 202 does not perform an interference prevention control operation for the wireless device to be an interference source, and ends the operation.

If the control unit 202 determines that there is not a wireless device to be one of the interference sources registered in the interference management table 208 (“No” in step D4), there is not a wireless device that is an interference source to be subjected to interference prevention control. Therefore, the control unit 202 ends the operation.

If the control unit 202 determines that the reception data received from the communication unit 201 is not reception data from the associated wireless access point AP₁ (“No” in step D1), the control unit 202 determines whether radio interference is caused between the radio wave of the reception data received from the communication unit 201 and the radio wave from the associated wireless access point AP₁, based on the received signal strength measured by the unit 205 (step D6).

For example, the control unit 202 compares the received signal strength RI of the associated wireless access point AP₁ stored in the memory unit 203 with the received signal strength R2 measured by the unit 205, and determines whether the received signal strength ratio (R=R1/R2) between the received signal strength R1 of the associated wireless access point AP₁ and the received signal strength R2 measured by the unit 205 is equal to or higher than a predetermined threshold value α (R≧α, or R≦α). If the received signal strength ratio R is determined to be equal to or higher than the predetermined threshold value α (R≧α), the control unit 202 determines that the radio wave R2 of the reception data received from the communication unit 201 does not cause radio interference with the radio wave R1 from the associated wireless access point AP₁. If the received signal strength ratio R is determined to be lower than the predetermined threshold value α (R<α), the control unit 202 determines that the radio wave R2 of the reception data received from the communication unit 201 causes radio interference with the radio wave R1 from the associated wireless access point AP₁.

If the control unit 202 determines that radio interference is caused between the radio wave of the reception data received from the communication unit 201 and the radio wave from the associated wireless access point AP₁ (“Yes” in step D6), the control unit 202 determines that the wireless device is one of the interference sources that cause radio interference with radio waves from the associated wireless access point AP₁, and registers the address of the wireless device contained in the reception data received from the communication unit 201 in the table 208 in the memory unit 203. By doing so, the wireless station STA can utilize the table 208 to manage the information as to the wireless devices to be interference sources that cause radio interference with radio waves from the associated wireless access point AP₁ (step D7). If the address of the wireless device is determined to be already registered in the table 208, the control unit 202 does not register the address of the wireless device in the table 208, and ends the operation.

If the control unit 202 determines that radio interference is not caused between the radio wave of the reception data received from the communication unit 201 and the radio wave from the associated wireless access point AP₁ (“No” in step D6), the control unit 202 determines that the wireless device is not a wireless device as one of the interference sources that cause radio interference with radio waves from the associated wireless access point AP₁, and determines whether the address of the wireless device contained in the reception data received from the communication unit 201 is registered in the table 208. If the address of the wireless device is determined to be already registered in the table 208, the control unit 202 deletes the address of the wireless device from the table 208 (step D8).

By doing so, the wireless station STA can utilize the table 208 to manage the addresses of wireless devices to be the interference sources that cause radio interference with radio waves from the associated wireless access point AP₁. Thus, the wireless station STA can transfer an interference prevention message to the subject wireless device to be an interference source that causes radio interference with radio waves from the associated wireless access point AP₁. If the address of the wireless device is determined not to be registered in the table 208, there are no addresses to be deleted from the table 208, and the control unit 202 ends the operation.

### (Series of Procedures in Wireless Communication System)

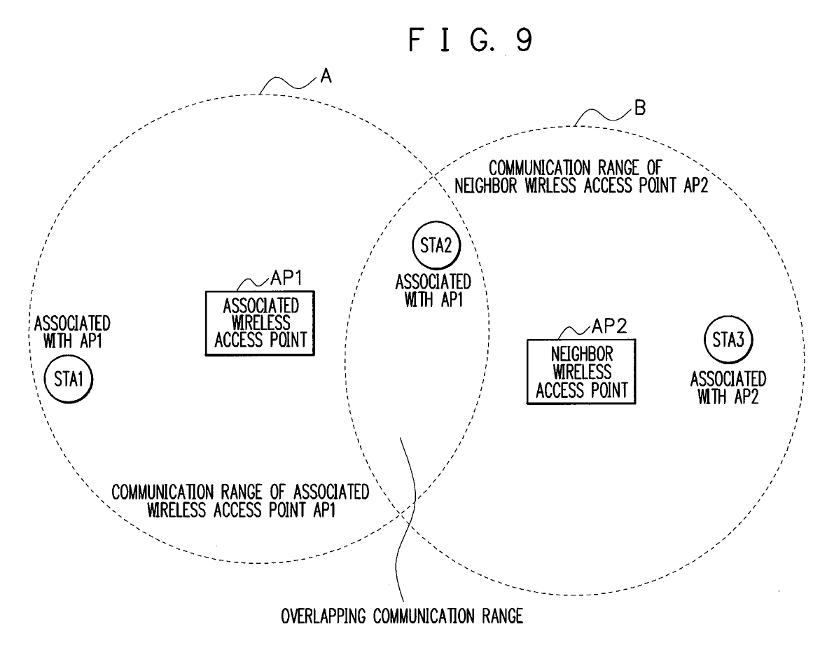

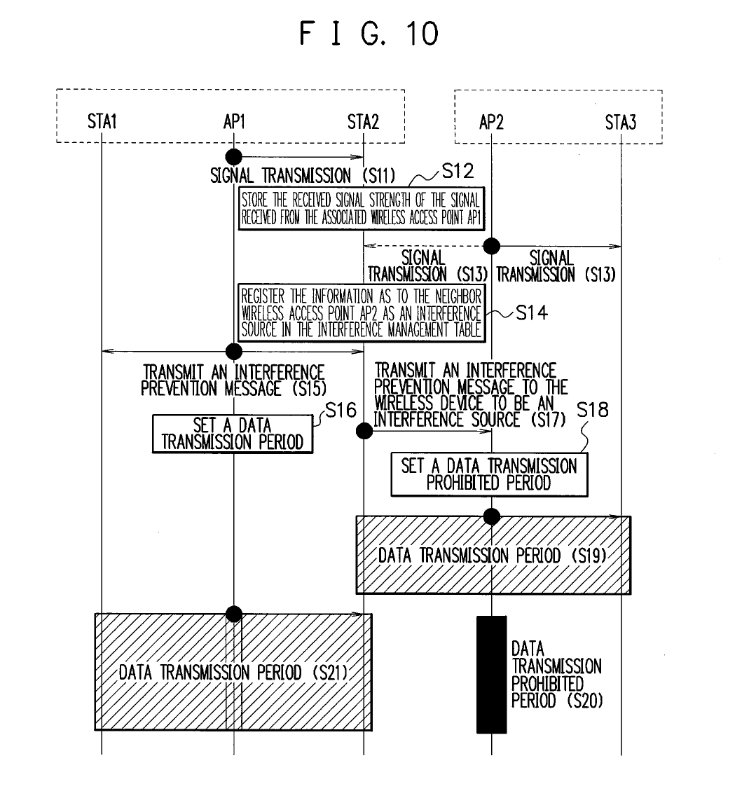

Referring now to FIGS. 9 and 10, a series of operations to be performed in the wireless communication system are described in detail. The series of procedures shown in FIG. 10 are to be carried out on the assumption that a wireless station STA₂ is located within an overlapping communication range where a communication range A of the wireless access point AP₁ and a communication range B of the wireless access point AP₂ overlap, as shown in FIG. 9.

As shown in FIG. 9, since the wireless access point AP₁ and the wireless access point AP₂ are not located in the communication range of each other, the s AP₁ and AP₂ cannot recognize the existence of each other neighbor wireless access point. The wireless access point AP₁ with which the wireless station STA₂ is associated is referred to as the associated wireless access point, and the wireless access point AP₂ with which the wireless station STA₂ is not associated is referred to as the neighbor wireless access point. In FIG. 9, a wireless station STA₁ is associated with the associated wireless access point AP₁, and a wireless station STA₃ is associated with the neighbor wireless access point AP₂.

First, the wireless station STA₂ receives a signal (such as a beacon signal or a probe response signal) transmitted from the associated wireless access point AP₁ (step S11).

The wireless station STA₂ analyzes the signal received from the associated wireless access point AP₁. If the signal is determined to be a signal received from the associated wireless access point AP₁, the wireless station STA₂ measures the received signal strength indicator (RSSI) of the signal received from the associated wireless access point AP₁ with the use of the unit 205, and stores the measured received signal strength of the associated wireless access point AP₁ in the memory unit 203 of the wireless station STA₂ (step S12). By doing so, the wireless station STA₂ can manage the received signal strength of the signal received from the associated wireless access point AP₁.

The wireless station STA₂ then receives a signal (such as a beacon signal) transmitted from the neighbor wireless access point AP₂ (step S13).

The wireless station STA₂ analyzes the signal received from the neighbor wireless access point AP₂. If the signal is determined to be a signal received from the neighbor wireless access point AP₂, the wireless station STA₂ measures the received signal strength indicator (RSSI) of the signal received from the neighbor wireless access point AP₂ with the use of the unit 205, and determines whether radio interference is caused between the neighbor wireless access point AP₂ and the associated wireless access point AP₁, based on the measured received signal strength of the neighbor wireless access point AP₂ and the received signal strength of the associated wireless access point AP₁ stored in the memory unit 203 of the wireless station STA₂.

If the wireless station STA₂ determines that radio interference is caused between the neighbor wireless access point AP₂ and the associated wireless access point AP₁, the neighbor wireless access point AP₂ is determined to be a wireless device that is an interference source. Based on the signal received from the neighbor wireless access point AP₂, the wireless station STA₂ registers the address of the neighbor wireless access point AP₂ contained in the received signal into the table 208 in the memory unit 203 (step S14). By doing so, the wireless station STA₂ utilizes the table 208 to manage the address of the neighbor wireless access point AP₂ that causes radio interference with radio waves from the associated wireless access point AP₁, as shown in FIG. 6.

To determines whether radio interference is caused between the neighbor wireless access point AP₂ and the associated wireless access point AP₁, the received signal strength ratio (R=R1/R2) between the received signal strength R1 of the associated wireless access point AP₁ and the received signal strength R2 of the neighbor wireless access point AP₂ is compared with the predetermined threshold value α, so as to determine whether the received signal strength ratio (R=R1/R2) is equal to or higher than the predetermined threshold value α. If the received signal strength ratio R is determined to be equal to or higher than the predetermined threshold value α (R≧α), the wireless station STA₂ determines that radio interference is not caused between the neighbor wireless access point AP₂ and the associated wireless access point AP₁. If the received signal strength ratio R is determined to be lower than the predetermined threshold value α (R<α), the wireless station STA₂ determines that radio interference is caused between the neighbor wireless access point AP₂ and the associated wireless access point AP₁.

As described above, when determining that the signal received by the wireless station STA₂ is a signal received from the neighbor wireless access point AP₂, not from the associated wireless access point AP₁, the wireless station STA₂ compares the received signal strength of the neighbor wireless access point AP₂ with the received signal strength of the associated wireless access point AP₁ stored in the memory unit 203 of the wireless station STA₂, so as to determine whether radio interference is caused between the neighbor wireless access point AP₂ and the associated wireless access point AP₁. If the wireless station STA₂ determines that radio interference is caused between the neighbor wireless access point AP₂ and the associated wireless access point AP₁, the neighbor wireless access point AP₂ is determined to be a wireless device that is an interference source, and the address of the neighbor wireless access point AP₂ is registered in the table 208 in the memory unit 203. By doing so, the wireless station STA₂ can utilize the memory unit 203 of the wireless station STA₂ to manage the information as to the wireless device AP₂ to be an interference source that causes radio interface with radio waves from the associated wireless access point AP1 with which the wireless station STA₂ is associated.

To determine whether radio interference is caused between the neighbor wireless access point AP₂ and the associated wireless access point AP₁, any techniques other than the above described technique of making a determination based on the received signal strength ratio can be utilized, as long as it is possible to determine whether radio interference is caused between the neighbor wireless access point AP₂ and the associated wireless access point AP₁, based on the received signal strength of the neighbor wireless access point AP₂ and the received signal strength of the associated wireless access point AP₁. For example, it is also possible to determine whether radio interference is caused between the neighbor wireless access point AP₂ and the associated wireless access point AP₁, based on the difference between the received signal strength of the neighbor wireless access point AP₂ and the received signal strength of the associated wireless access point AP₁.

The associated wireless access point AP₁ then broadcasts an interference prevention message (RTS: Request To Send) including the device information for performing data transmission to the wireless station STA₂ and the data transmission period to the wireless stations STA₁ and STA₂ located within the communication range of the associated wireless access point AP₁ (step S15). The associated wireless access point AP₁ then sets the data transmission period in which data transmission to the wireless station STA₂ is performed in the memory unit 103 of the associated wireless access point AP₁ (step S16).

Upon receipt of the interference prevention message broadcast from the associated wireless access point AP₁, the wireless station STA₂ determines whether the interference prevention message is about data transmission to the wireless station STA₂, based on the device information contained in the received interference prevention message.

Since the associated wireless access point AP₁ broadcasts an interference prevention message including the device information for performing data transmission to the wireless station STA₂ and the data transmission period, the wireless station STA₂ determines that the interference prevention message received from the associated wireless access point AP₁ is an interference prevention message about data transmission to the wireless station STA₂, which performs an interference prevention control operation.

Accordingly, the wireless station STA₂ refers to the table 208, and transfers the interference prevention message to the neighbor wireless access point AP₂ to be an interference source on a multicast, based on the addresses of the wireless devices registered in the table 208. The wireless station STA₂ also sets the data transmission period contained in the interference prevention message received from the associated wireless access point AP₁, as a data transmission prohibited period in the memory unit 203. By doing so, the wireless station STA₂ controls data transmission, so that data transmission is not performed in the data transmission prohibited period set in the memory unit 203 (step S17).

Like the wireless station STA₂, upon receipt of the interference prevention message broadcast from the associated wireless access point AP₁, the wireless station STA₁ located within the communication range of the associated wireless access point AP₁ determines whether the received interference prevention message is about data transmission to the wireless station STA₁.

Since the associated wireless access point AP₁ broadcasts an interference prevention message including the device information STA₂ for performing data transmission to the wireless station STA₂ and the data transmission period, the wireless station STA₁ determines that the interference prevention message is not an interference prevention message about data transmission to the wireless station STA₁. The wireless station STA₁ does not perform an interference prevention control operation for the wireless device to be the interference source, but sets the data transmission period contained in the interference prevention message as a data transmission prohibited period in the memory unit 203. By doing so, the wireless station STA₁ controls data transmission, so that data transmission is not performed in the data transmission prohibited period set in the memory unit 203.

Upon receipt of the interference prevention message from the wireless station STA₂, the neighbor wireless access point AP₂ sets the data transmission period contained in the received interference prevention message as a data transmission prohibited period in the memory unit 103 (step S18). In this manner, the neighbor wireless access point AP₂ is controlled so as not to perform data transmission in the data transmission prohibited period set in the memory unit 103.

If there is a transmission queue, the neighbor wireless access point AP₂ determines whether the transmission queue contains transmission data that can be transmitted before the data transmission prohibited period set in the memory unit 103. If it is determined that there is transmission data that can be transmitted before the data transmission prohibited period, the neighbor wireless access point AP₂ transmits the transmission data. To determine whether there is transmission data that can be transmitted before the data transmission prohibited period, the neighbor wireless access point AP₂ makes a determination based on information such as the packet length and transmission rate of the transmission data.

If it is determined that the transmission queue does not include transmission data that is transmitted before the data transmission prohibited period, the neighbor wireless access point AP₂ waits until the data transmission prohibited period set in the memory unit 103 comes. In the data transmission prohibited period, the neighbor wireless access point AP₂ is controlled so as not to perform data transmission.

Since the neighbor wireless access point AP₂ determines that the transmission data to be transmitted to the wireless station STA₃ can be transmitted before the data transmission prohibited period, the neighbor wireless access point AP₂ transmits the transmission data to the wireless station STA₃ (step S19). After the data transmission is completed, the neighbor wireless access point AP₂ waits until the data transmission prohibited period set in the memory unit 103 comes. Once in the data transmission prohibited period, the neighbor wireless access point AP₂ is controlled so as not to perform data transmission (step S20). After the data transmission prohibited period has passed, the neighbor wireless access point AP₂ is controlled so as to perform data transmission.

When the associated wireless access point AP₁ determines that it has entered the data transmission period for the wireless station STA₂, based on the data transmission period set in the memory unit 103 in step S16, the associated wireless access point AP₁ starts data transmission to the wireless station STA₂ (step S21). Here, the neighbor wireless access point AP₂ is controlled not to perform data transmission, as the data transmission prohibited period is set in the memory unit 103. Accordingly, radio interference is not caused between the associated wireless access point AP₁ and the neighbor wireless access point AP₂. With this arrangement, the wireless station STA₂ can surely receive transmission data transmitted from the associated wireless access point AP₁.

As described above, when the wireless station STA₂ of the wireless communication system detects the wireless device AP₂ to be an interference source that causes radio interference with radio waves from the associated wireless access point AP₁ with which the wireless station STA₂ is associated, the wireless station STA₂ utilizes the table 208 to manage the device information as to the detected wireless device AP₂ to be the interference source. Upon receipt of an interference prevention message directed to the wireless station STA₂ from the associated wireless access point AP₁, the wireless station STA₂ transmits the interference prevention message to the wireless device AP₂ to be the interference source managed through the table 208. Upon receipt of the interference prevention message transmitted from the wireless station STA₂, the wireless device AP₂ as the interference source sets the data transmission period contained in the interference prevention message as a data transmission prohibited period, and controls data transmission so that no data transmission is performed in the data transmission prohibited period.

With the above described arrangement, even when the associated wireless access point AP₁ cannot recognize the existence of the wireless device AP₂ to be an interference source that causes radio interference with radio waves from the associated wireless access point AP₁, the wireless station STA₂ controls the wireless device AP₂ to be the interference source, and prevents radio interference between the associated wireless access point AP₁ and the wireless device AP₂.

### Second Exemplary Embodiment

Next, a second exemplary embodiment is described.

As shown in FIG. 6, a wireless communication system in accordance with the first exemplary embodiment utilizes the interference management table 208 to manage the address (the interference prevention address) of the wireless device AP₂ to be an interference source that causes radio interference with radio waves from the associated wireless access point AP₁, and the wireless station STA₂ transmits an interference prevention message on a multicast to the wireless device AP₂ to be the interference source that cause radio interference with radio waves from the associated wireless access point AP₁.

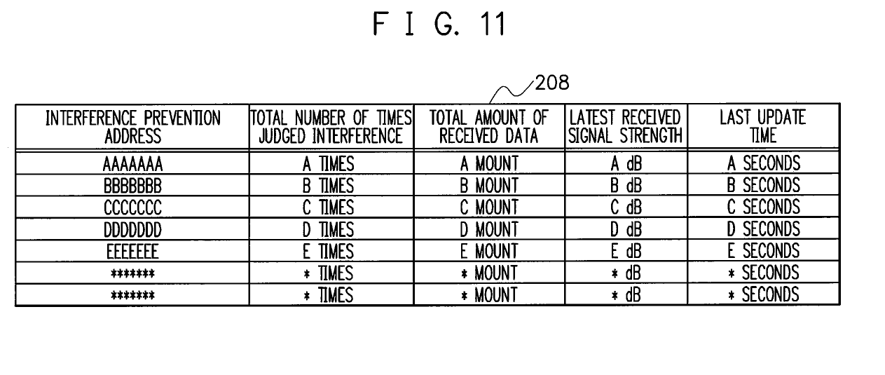

As shown in FIG. 11, a wireless communication system in accordance with the second exemplary embodiment utilizes the interference management table 208 to manage not only the address (the interference prevention address) of the wireless device AP₂ to be an interference source that causes radio interference with radio waves from the associated wireless access point AP₁, but also at least one piece of related information that includes the “total number of times judged interference” indicating the number of times the wireless device AP₂ is determined to be an interference source that causes radio interference, the “total amount of received data” indicating the total amount of data received from the wireless device AP₂ to be an interference source, and the “latest received signal strength” received from the wireless device AP₂ to be an interference source. Based on the related information managed in the table 208, the wireless station STA₂ transmits an interference prevention message on a unicast to a wireless device to be an interference source having a particularly high radio interference occurrence rate (a wireless device to be an interference source having a large total number of time judged interference or a large total amount of received data), or to a wireless device to be an interference source having a low rate of interference prevention message reception (a wireless device to be an interference source having a low latest received signal strength).

With this arrangement, the wireless station STA₂ transmits an interference prevention messages on a unicast, not on a multicast, to a wireless device to be an interference source having a high radio interference occurrence rate or a wireless device to be an interference source having a low interference prevention message reception among the wireless devices to be interference sources that cause radio interference with radio waves from the associated wireless access point AP₁. Accordingly, radio interference between the wireless access point AP₁ and any wireless device to be an interference source can be prevented with high certainty.

In the wireless communication system in FIG. 11, the “last update time” indicating the time at which the information is registered or updated in the table 208 is managed together with the addresses (the interference prevention addresses) of the wireless devices to be interference sources.

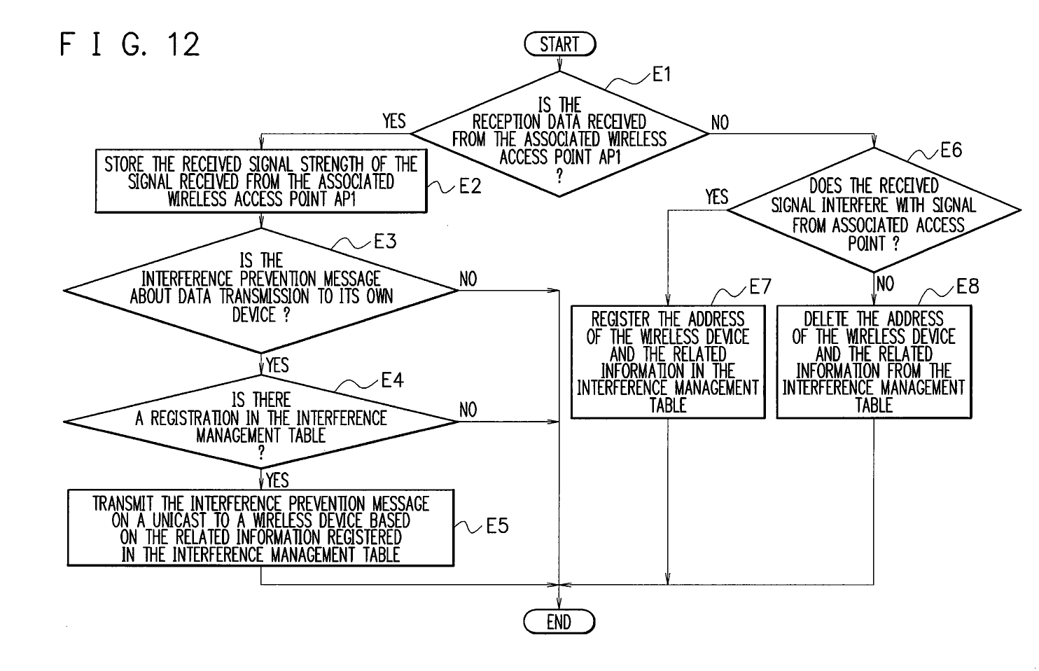

With this arrangement, the time information indicating the time at which the address of the wireless device to be an interference source is registered or updated in the table 208 is managed in the table 208. Accordingly, if there is the information as to a wireless device to be an interference source that has not been updated over a predetermined period of time and managed in the table 208, the information as to the wireless device to be an interference source is deleted from the table 208, so that the latest information as to the wireless devices to be interference sources that cause radio interference with radio waves from the associated wireless access point AP₁ can be managed in the table 208. Referring now to FIGS. 11 and 12, the wireless communication system is described.

The procedures of steps E1 through E4, shown in FIG. 12, are the same as the procedures of steps D1 through D4 in the operation in accordance with the first exemplary embodiment shown in FIG. 8.

As shown in FIG. 11, the wireless station STA₂ utilizes the table 208 to manage not only the address (the interference prevention address) of the wireless device AP₂ to be an interference source that causes radio interference with radio waves from the associated wireless access point AP₁, but also at least one piece of related information that includes the “total number of times judged interference” indicating the number of times the wireless device AP₂ is determined to be an interference source that causes radio interference, the “total amount of received data” indicating the total amount of data received from the wireless device AP₂ to be an interference source, and the “latest received signal strength” received from the wireless device AP₂ to be an interference source. Therefore, if the control unit 202 determines that there is the information as to a wireless device registered in the table 208 (“Yes” in step E4), the control unit 202 identifies the wireless device to be an interference source to which an interference prevention message is to be transmitted on a unicast, based on the related information registered in the table 208. The control unit 202 then transfers the interference prevention message on a unicast to the identified wireless device to be an interference source (step E5).

More specifically, the control unit 202 transmits an interference prevention message on a unicast, not on a multicast, to a wireless device that is determined to have the “total number of times judged interference” managed in the table 208 which is equal to or larger than a predetermined threshold value, or a wireless device that is determined to have a “total amount of received data” equal to or larger than a predetermined threshold value, or a wireless device that is determined to have the “latest received signal strength” lower than a predetermined threshold value, for example.

With this arrangement, the wireless station STA₂ transmits an interference prevention message on a unicast, not on a multicast, to a wireless device having a high radio interference occurrence rate (a wireless device determined to have the “total number of times judged interference” equal to or larger than the predetermined threshold value, or a wireless device determined to have a “total amount of received data” equal to or larger than the predetermined threshold value), or to a wireless device having a low interference prevention message reception rate (a wireless device determined to have the “latest received signal strength” lower than the predetermined threshold value). In this manner, the wireless station STA₂ transmits an interference prevention message to a wireless device to be an interference source with certainty. Thus, radio interference between the wireless access point AP₁ and the wireless device AP₂ to be an interference source are prevented with certainty.

If the reception data received from the communication unit 201 is determined not to be reception data from the associated wireless access point AP₁ in step E1 (“No” in step E1), the control unit 202 determines whether the radio wave of the reception data received from the communication unit 201 causes radio interference with a radio wave from the associated wireless access point AP₁, based on the received signal strength measured by the unit 205 (step E6).

If the control unit 202 determines that the radio wave of the reception data received from the communication unit 201 causes radio interference with a radio wave from the associated wireless access point AP₁ (“Yes” in step E6), the control unit 202 determines that the subject wireless device is a wireless device to be an interference source that causes radio interference with radio waves from the associated wireless access point AP₁. The control unit 202 then registers the total number of times judged interference, the data amount of the reception data, the received signal strength, and the last update time, as well as the address (the interference prevention address) of the wireless device contained in the reception data received from the communication unit 201, in the table 208 (step E7).

If the control unit 202 determines that the address of the wireless device is already registered in the table 208, the control unit 202 adds only “1” to the “total number of times judged interference” managed together with the address of the wireless device in the table 208, so as to increment the “total number of times judged interference”. The control unit 202 also adds the data amount of the reception data received this time to the “total amount of received data”, so as to increment the “total amount of received data”. The control unit 202 also updates the received signal strength to the received signal strength of the reception data received this time, so as to set the “latest received signal strength”. The control unit 202 also updates the “last update time” to the time information indicating the time of this update, so as to set the latest “last update time”.

With this arrangement, the wireless station STA₂ can utilize the table 208 to manage the related information that includes the “total number of times judged interference” indicating the number of times the wireless device is determined to be an interference source that causes radio interference with radio waves from the associated wireless access point AP₁, the “total amount of received data” indicating the amount of data received from the wireless device to be an interference source, and the “latest received signal strength” received from the wireless device to be an interference source. The wireless station STA₂ can also utilize the table 208 to manage the “last update time” indicating the time at which the address of the wireless device to be an interference source is registered or updated.

If the control unit 202 determines that the radio wave of the reception data received from the communication unit 201 does not cause radio interference with radio waves from the associated wireless access point AP₁ (“No” in step E6), the control unit 202 determines whether the address of the wireless device contained in the reception data received from the communication unit 201 is an address registered in the table 208. If the address of the wireless device is determined to be an address registered in the table 208, the control unit 202 deletes the information as to the wireless device from the table 208 (step E8).

Since the wireless station STA₂ utilizes the table 208 to manage the latest information as to the wireless device to be an interference source that causes radio interference with radio waves from the associated wireless access point AP₁, the wireless station STA₂ can transfer an interference prevention message to the wireless device to be an interference source that causes radio interference with radio waves from the associated wireless access point AP₁. If the control unit 202 determines that the address of the wireless device is not registered in the table 208, there is not an address to be deleted from the table 208, and the control unit 202 ends the operation.

The “last update time” is managed, together with the addresses of the wireless devices to be interference sources, in the table 208. Therefore, if the control unit 202 determines that there is a wireless device having “last update time” that has not been updated over a predetermined period of time, the control unit 202 deletes the information as to the wireless device to be an interference source from the table 208.

With this arrangement, the wireless station STA₂ can utilize the table 208 to manage the latest information as to the wireless devices to be interference sources that cause radio interference with radio waves from the associated wireless access point AP₁.

The time when the control unit 202 determines, with reference to the table 208 whether there is a wireless device having “last update time” that has not been updated over a predetermined period of time is not particularly limited, and various conditions can be triggers for determining whether there is a wireless device having “last update time” that has not been updated over a predetermined period of time.

As described above, in the wireless communication system in accordance with the second exemplary embodiment, when the wireless station STA₂ detects a wireless device to be an interference source that causes radio interference with radio waves from the associated wireless access point AP₁, the wireless station STA₂ utilizes the table 208 to manage not only the address (the interference prevention address) of the wireless device to be an interference source, but also at least one piece of related information that includes the “total number of times judged interference” indicating the number of times the wireless device is determined to be an interference source, the “total amount of received data” indicating the total amount of data received from the wireless device to be an interference source, and the “latest received signal strength” received from the wireless device to be an interference source. Based on the related information managed in the table 208, the wireless station STA₂ transmits an interference prevention message on a unicast to a wireless device to be an interference source having a high radio interference occurrence rate (a wireless device to be an interference source having a large “total number of times judged interference” or a large “total amount of received data”), or to a wireless device to be an interference source having a low interference prevention message reception rate (a wireless device to be an interference source having a low “latest received signal strength”).

With this arrangement, the wireless station STA₂ transmits an interference prevention message on a unicast, not on a multicast, to a wireless device having a high radio interference occurrence rate or a wireless device having a low interference prevention message reception rate among the wireless devices to be interference sources that cause radio interference with radio waves from the associated wireless access point AP₁. In this manner, radio interference between the wireless access point AP₁ and the wireless device AP₂ to be an interference source can be prevented with certainty.

When the wireless station STA₂ detects a wireless device to be an interference source that causes radio wave interference with radio waves from the associated wireless access point AP₁, the wireless station STA₂ also utilizes the table 208 to manage the “last update time” indicating the time at which the address of the wireless device to be an interference source is registered or updated in the table 208, as well as the address (the interference prevention address) of the wireless device.

With this arrangement, if the wireless station STA₂ determines that there is a wireless device having information that has not been updated over a predetermined period of time in the table 208, based on the “last update time” managed in the table 208, the information as to the wireless device to be an interference source is deleted from the table 208. In this manner, all the information as to wireless devices that used to be interference sources and no longer cause radio interference with radio waves from the associated wireless access point AP₁ can be deleted from the table 208. Accordingly, the wireless station STA₂ does not transmit an interference prevention message to any wireless device that no longer causes radio interference with radio waves from the associated wireless access point AP₁. Thus, the processing load of the wireless station STA₂ can be reduced.

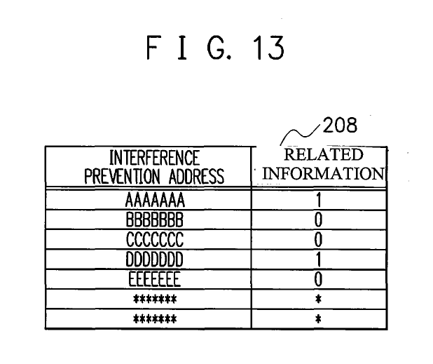

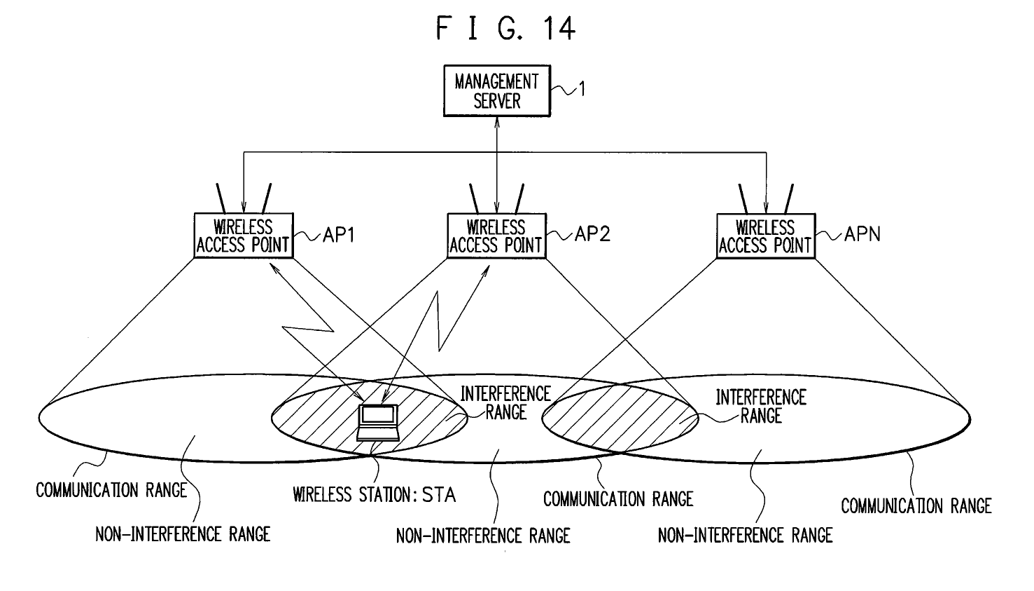

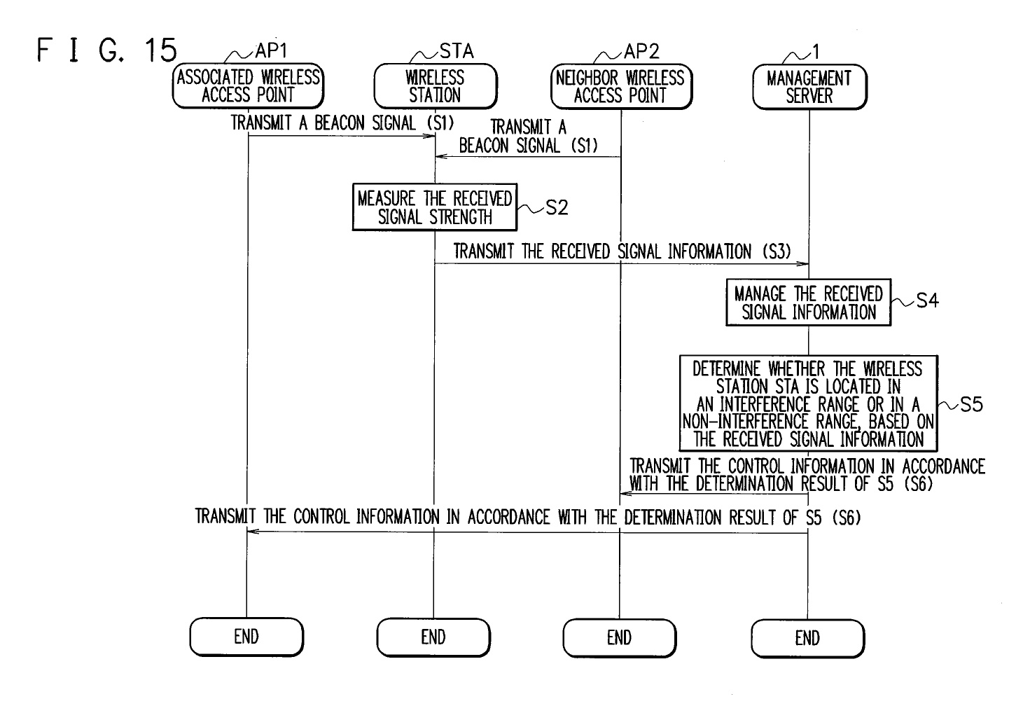

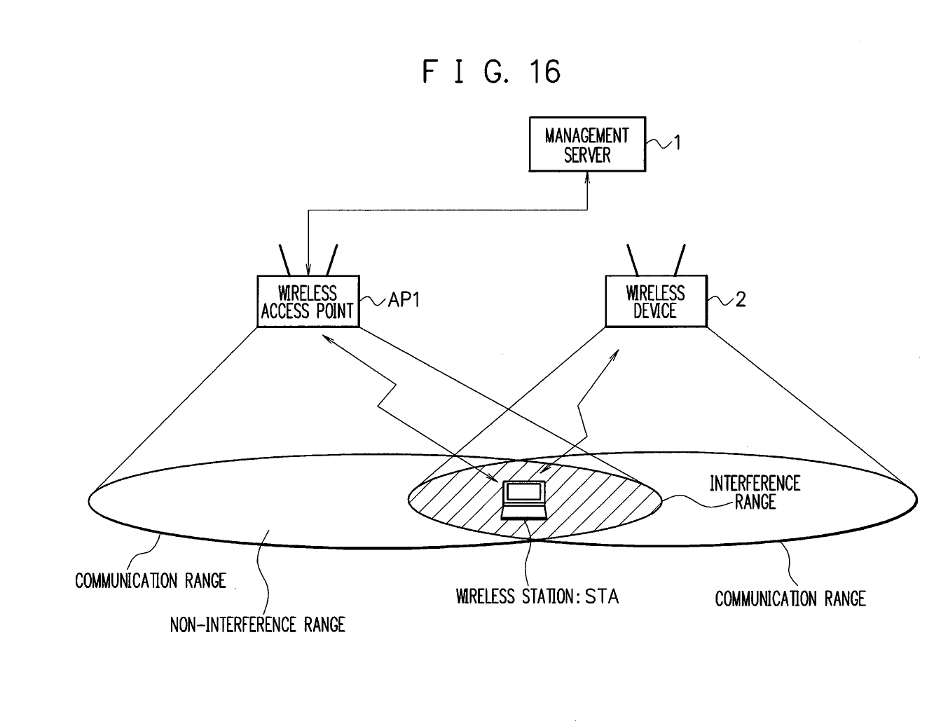

In the above described second embodiment, the table 208 manages not only the address (the interference prevention address) of the wireless device to be an interference source that causes radio interference with radio waves from the associated wireless access point AP₁, but also at least one piece of related information that includes the “total number of times judged interference” indicating the number of times the wireless device is determined to be an interference source that causes radio interference, the “total amount of received data” indicating the total amount of data received from the wireless device to be an interference source, and the “latest received signal strength” received from the wireless device to be an interference source, as shown in FIG. 11. Based on the related information registered in the table 208, the wireless device to be an interference source to which an interference prevention message is to be transmitted on a unicast is identified, and the interference prevention message is transferred on a unicast to the identified wireless device to be an interference source. However, as shown in FIG. 13, the table 208 may manage the “related information” for identifying the wireless device to be an interference source to which an interference prevention message is to be transmitted on a unicast, as well as the address (the interference prevention address) of the wireless device to be an interference source that causes radio interference with radio waves from the associated wireless access point AP₁. Based on the “related information” managed in the table 208, an interference prevention message may be transferred on a unicast to the identified wireless device to be an interference source.

For example, in FIG. 13, where the “related information” is “0”, the wireless device is determined to be a wireless device as an interference source to which an interference prevention message is to be transmitted on a multicast. Where the “related information” is “1”, the wireless device is determined to be a wireless device as an interference source to which an interference prevention message is to be transmitted on a unicast. It should be noted that the “related information” shown in FIG. 13 is merely an example, and any information may be employed as the “related information”, as long as the wireless device as an interference source to which an interference prevention message is to be transmitted on a unicast can be identified.

To register the “related information: 1 or 0” for identifying the wireless device as an interference source to which an interference prevention message is to be transmitted on a unicast, as well as the address (the interference prevention address) of the wireless device as an interference source that causes radio interference with radio waves from the associated wireless access point AP₁, in the table 208, as shown in FIG. 13, the following first through third registration methods may be utilized, for example.

By the first registration method, when the wireless device address (the interference prevention address) contained in the reception data received from the communication unit 201 is registered in the table 208 in step E7 of FIG. 12, the control unit 202 determines whether the “total number of times judged interference” in the reception data received from the wireless device is equal to or larger than a predetermined threshold value. If the “total number of times judged interference” is determined to be equal to or larger than the predetermined threshold value, the wireless device is determined to be a wireless device as an interference source having a high radio interference occurrence rate, and the “related information: 1” for transmitting an interference prevention message on a unicast is registered in the table 208. If the “total number of times judged interference” is determined to be smaller than the predetermined threshold value, the wireless device is determined to be a wireless device as an interference source having a low radio interference occurrence rate, and the “related information: 0” for transmitting an interference prevention message on a multicast is registered in the table 208.

By the second registration method, the control unit 202 determines whether the “total amount of received data” of the reception data received from the subject wireless device is equal to or larger than a predetermined threshold value. If the “total amount of received data” is determined to be equal to or larger than the predetermined threshold value, the wireless device is determined to be a wireless device as an interference source having a high radio interference occurrence rate, and the “related information: 1” for transmitting an interference prevention message on a unicast is registered in the table 208. If the “total amount of received data” is determined to be smaller than the predetermined threshold value, the wireless device is determined to be a wireless device as an interference source having a low radio interference occurrence rate, and the “related information: 0” for transmitting an interference prevention message on a multicast is registered in the table 208.

By the third registration method, the control unit 202 determines whether the “received signal strength” of the reception data received from the subject wireless device is smaller than a predetermined threshold value. If the “received signal strength” is determined to be smaller than the predetermined threshold value, the wireless device is determined to be a wireless device as an interference source having a low interference prevention message reception rate, and the “related information: 1” for transmitting an interference prevention message on a unicast is registered in the table 208. If the “received signal strength” is determined to be equal to or larger than the predetermined threshold value, the wireless device is determined to be a wireless device as an interference source having a high interference prevention message reception rate, and the “related information: 0” for transmitting an interference prevention message on a multicast is registered in the table 208.

Alternatively, the above described first through third registration methods may be arbitrarily combined. Based on at least one of the “total number of times judged interference”, the “total amount of received data”, and the “received signal strength”, the control unit 202 may determine whether the subject wireless device is a wireless device to be an interference source to which an interference prevention message is to be transmitted on a unicast, and register the “related information: 1” for identifying a wireless device as an interference source to which an interference prevention message is to be transmitted on a unicast in the table 208.

Meanwhile, the condition for deleting the information as to a wireless device to be an interference source managed in the table 208 is not limited to the above described “last update time”. For example, the information as to a wireless device to be an interference source managed in the table 208 may be deleted by a delete requesting operation performed through the operating unit 204, or the information as to a wireless device to be an interference source managed in the table 208 may be deleted when the associated wireless access point AP₁ to which the wireless station STA is changed.

### Third Exemplary Embodiment

The wireless station may further comprise a control signal receiving unit that receives the control signal from the wireless access point. The control signal transmitting unit transmits the control signal received through the control signal receiving unit.

### Fourth Exemplary Embodiment

The control signal transmitting unit may transmit the control signal, when the control signal received through the control signal receiving unit is a control signal directed to the wireless station.

### Fifth Exemplary Embodiment

The interference source detecting unit may include an interference source determining unit that determines whether a neighbor wireless device located in the vicinity of the wireless station is the wireless device to be an interference source, based on a first received signal strength received from the wireless access point and a second received signal strength received from the neighbor wireless device.

### Sixth Exemplary Embodiment

The interference source determining unit may determine whether the neighbor wireless device is the wireless device to be an interference source, based on a received signal strength ratio between the first received signal strength and the second received signal strength.

### Seventh Exemplary Embodiment

The interference source determining unit may determine that the neighbor wireless device is the wireless device to be an interference source, when the received signal strength ratio is lower than a predetermined threshold value.

### Eighth Exemplary Embodiment

The wireless station may further comprise an interference source managing unit that manages device information as to the wireless device to be an interference source. The control signal transmitting unit transmits the control signal to the wireless device, based on the device information managed by the interference source managing unit.

### Ninth Exemplary Embodiment

The wireless station in accordance with the present invention is also characterized in that: when the interference source determining unit determines that the neighbor wireless device is the wireless device to be an interference source, the device information as to the neighbor wireless device is registered or updated in the interference source managing unit; and when the interference source determining unit determines that the neighbor wireless device is not the wireless device to be an interference source, the device information as to the neighbor wireless device is deleted from the interference source managing unit.

### Tenth Exemplary Embodiment

The interference source managing unit may manage the device information and related information for identifying the wireless device to which the control signal is to be transmitted on a unicast. The control signal transmitting unit may transmit the control signal on a unicast to the wireless device identified based on the related information.

### Eleventh Exemplary Embodiment

The interference source managing unit may manage the device information and related information that includes at least one of a total number of times the interference source determining unit determines a subject wireless device is the wireless device, a total amount of received data of the wireless device, and a latest received signal strength received from the wireless device. The control signal transmitting unit may identify the wireless device to which the control signal is to be transmitted on a unicast, based on the related information, and transmits the control signal on a unicast to the identified wireless device.

### Twelfth Exemplary Embodiment

The control signal transmitting unit may identify the wireless device to which the control signal is to be transmitted on a unicast, when the total number of times is equal to or larger than a predetermined threshold value, the total amount of received data is equal to or larger than a predetermined threshold value, or the latest received signal strength is smaller than a predetermined threshold value.

### Thirteenth Exemplary Embodiment

When the interference source determining unit determines that the neighbor wireless device is the wireless device to be an interference source, the device information as to the neighbor wireless device may be registered or updated in the interference source managing unit, and, when the interference source determining unit determines that a total number of times the neighbor wireless device is determined to be the wireless device is equal to or larger than a predetermined threshold value, or that a total amount of received data of the wireless device is equal to or larger than a predetermined threshold value, or that a received signal strength received from the wireless device is smaller than a predetermined threshold value, the related information for identifying the wireless device to which the control signal is to be transmitted on a unicast may be registered or updated in the interference source managing unit. When the interference source determining unit determines that the neighbor wireless device is not the wireless device to be an interference source, the device information as to the neighbor wireless device may be deleted from the interference source managing unit.

### Fourteenth Exemplary Embodiment

The interference source managing unit may manage the device information and last update time indicating a time at which the device information is registered or updated in the interference source managing unit. When the last update time is not updated over a predetermined period of time, the interference source managing unit may delete the device information from the interference source managing unit.

### Fifteenth Exemplary Embodiment

The control signal may include period information. The control signal transmitting unit may transmit the control signal including the period information, so as to cause the wireless device to perform control to prevent the radio interference in a period of time represented by the period information.

### Sixteenth Exemplary Embodiment

In the wireless communication system, the wireless access point may include a control signal transmitting unit that transmits the control signal to a wireless station, and the wireless station may include a control signal receiving unit that receives the control signal from the wireless access point wherein the control signal transmitting unit transmits the control signal received through the control signal receiving unit.

### Seventeenth Exemplary Embodiment

In the wireless communication system, the control signal transmitting unit may transmit the control signal, when the control signal received through the control signal receiving unit is a control signal directed to the wireless station.

### Eighteenth Exemplary Embodiment

In the wireless communication system, the interference source detecting unit may include an interference source determining unit that determines whether a neighbor wireless device located in the vicinity of the wireless station is the wireless device to be an interference source, based on a first received signal strength received from the wireless access point and a second received signal strength received from the neighbor wireless device.

### Nineteenth Exemplary Embodiment

In the wireless communication system, the interference source determining unit may determine whether the neighbor wireless device is the wireless device to be an interference source, based on a received signal strength ratio between the first received signal strength and the second received signal strength.

### Twentieth Exemplary Embodiment

In the wireless communication system, the interference source determining unit may determine that the neighbor wireless device is the wireless device to be an interference source, when the received signal strength ratio is lower than a predetermined threshold value.

### Twenty-first Exemplary Embodiment

In the wireless communication system, the wireless station may further include: an interference source managing unit that manages device information as to the wireless device to be an interference source; and the control signal transmitting unit transmits the control signal to the wireless device, based on the device information managed by the interference source managing unit.

### Twenty-second Exemplary Embodiment

In the wireless communication system, when the interference source determining unit determines that the neighbor wireless device is the wireless device to be an interference source, the device information as to the neighbor wireless device may be registered or updated in the interference source managing unit. When the interference source determining unit determines that the neighbor wireless device is not the wireless device to be an interference source, the device information as to the neighbor wireless device may be deleted from the interference source managing unit.

### Twenty-third Exemplary Embodiment

In the wireless communication system, the interference source managing unit may manage the device information and related information for identifying the wireless device to which the control signal is to be transmitted on a unicast, and the control signal transmitting unit may transmit the control signal on a unicast to the wireless device identified based on the related information.

### Twenty-fourth Exemplary Embodiment

In the wireless communication system, the interference source managing unit may manage the device information and related information that includes at least one of a total number of times the interference source determining unit determines a subject wireless device is the wireless device, a total amount of received data of the wireless device, and a latest received signal strength received from the wireless device; and the control signal transmitting unit may identify the wireless device to which the control signal is to be transmitted on a unicast, based on the related information, and transmits the control signal on a unicast to the identified wireless device.

### Twenty-fifth Exemplary Embodiment

In the wireless communication system, the control signal transmitting unit may identify the wireless device to which the control signal is to be transmitted on a unicast, when the total number of times is equal to or larger than a predetermined threshold value, the total amount of received data is equal to or larger than a predetermined threshold value, or the latest received signal strength is smaller than a predetermined threshold value.

### Twenty-sixth Exemplary Embodiment

In the wireless communication system, when the interference source determining unit determines that the neighbor wireless device is the wireless device to be an interference source, the device information as to the neighbor wireless device may be registered or updated in the interference source managing unit, and when the interference source determining unit determines that a total number of times the neighbor wireless device is determined to be the wireless device is equal to or larger than a predetermined threshold value, or that a total amount of received data of the wireless device is equal to or larger than a predetermined threshold value, or that a received signal strength received from the wireless device is smaller than a predetermined threshold value, the related information for identifying the wireless device to which the control signal is to be transmitted on a unicast may be registered or updated in the interference source managing unit; and when the interference source determining unit determines that the neighbor wireless device is not the wireless device to be an interference source, the device information as to the neighbor wireless device may be deleted from the interference source managing unit.

### Twenty-seventh Exemplary Embodiment

In the wireless communication system, the interference source managing unit may manage the device information and last update time indicating a time at which the device information is registered or updated in the interference source managing unit. When the last update time is not updated over a predetermined period of time, the interference source managing unit may delete the device information from the interference source managing unit.

### Twenty-eighth Exemplary Embodiment

In the wireless communication system, the wireless access point may transmit the control signal including period information; and the wireless station may transmit the control signal including period information, so as to cause the wireless device to perform control to prevent the radio interference in a period of time represented by the period information.

Various changes and modifications may be made to the above exemplary embodiments within the scope of the present invention.

For example, in a wireless communication system in accordance with any of the above described exemplary embodiments, upon receipt of an interference prevention message directed to the wireless station STA₂ from the associated wireless access point AP₁, the wireless station STA₂ transmits the interference prevention message to the wireless device AP₂ to be an interference source managed in the table 208 (step S17), as shown in FIG. 10. Upon receipt of the interference prevention message transmitted from the wireless station STA₂, the wireless device AP₂ to be an interference source sets the data transmission period contained in the interference prevention message as a data transmission prohibited period (step S18), so that data transmission is not performed in the data transmission prohibited period (step S20). However, after the wireless device AP₂ to be an interference source sets the data transmission period for performing data transmission to the wireless station STA₃, the wireless station STA₂ transmits the interference prevention message to the wireless device AP₂ to be an interference source (step S17). The wireless device AP₂ to be an interference source then receives the interference prevention message transmitted from the wireless station STA₂. When the wireless device AP₂ sets the data transmission period contained in the received interference prevention message as the data transmission prohibited period, the wireless device AP₂ to be an interference source transmits overlap information to the wireless station STA₂, if the set period to be set as the data transmission prohibited period has already been set as the data transmission period. The overlap information indicates that the set period to be set as the data transmission prohibited period has already been set as the data transmission period. The wireless station STA₂ then transmits the overlap information received from the wireless device AP₂ to be an interference source to the associated wireless access point AP₁. Based on the overlap information received from the wireless station STA₂, the associated wireless access point AP₁ may adjust the data transmission period for the wireless station STA₂.

As described above, the wireless access points AP₁ and AP₂ adjacent to each other exchange information by multi-hop communications via the wireless station STA₂, and the transmission period for performing data transmission may be adjusted so as not to cause radio interference between the wireless access points AP₁ and AP₂.

The wireless device AP₂ to be an interference source receives an interference prevention message transmitted from the wireless station STA₂, and sets the data transmission period contained in the received interference prevention message as a data transmission prohibited period. Even where the period to be set as the data transmission prohibited period has already been set as a data transmission period, the wireless device AP₂ to be an interference source may forcibly set the data transmission period contained in the interference prevention message received from the wireless station STA₂ as a data transmission prohibited period.

Also, in each wireless communication system in accordance with the above described exemplary embodiments, the wireless access points AP₁ and AP₂ adjacent to each other may be connected with a cable line, and the wireless access points AP₁ and AP₂ adjacent to each other may form one system. Alternatively, the wireless access points AP₁ and AP₂ adjacent to each other may not be connected with a cable line, and the wireless access points AP₁ and AP₂ adjacent to each other may form different systems from each other. As long as the wireless access points AP₁ and AP₂ adjacent to each other can exchange information by multi-hop communications via the wireless station STA, the structure between the wireless access points AP₁ and AP₂ adjacent to each other is not particularly restricted, and may be employed in any system.

The above description of each wireless communication system in accordance with the above described exemplary embodiments centers around the wireless station STA. However, any other wireless device may be employed as long as the wireless device freely moves in the communication range of any wireless access point AP₁, is associated with a given wireless access point AP₁, and performs wireless communications with the wireless access point AP₁ with which the wireless device is associated.

In each wireless communication system in accordance with the above described exemplary embodiments, the wireless access point AP₂ is described as a wireless device to be an interference source that causes radio interference with radio waves from the associated wireless access point AP₁. However, any other wireless device may be a wireless device to be an interference source, as long as the wireless station STA₂ can be detected as a wireless device to be an interference source that causes radio interference with radio waves from the associated wireless access point AP₁. For example, a wireless station may be a wireless device to be an interference source.

The control operations to be performed by the wireless devices such as the wireless access points AP₁ and AP₂ and the wireless station STA of the wireless communication systems may be realized by software such as computer programs, instead of a hardware structure. Such programs may be recorded on a computer-readable medium such as an optical recording medium, a magnetic recording medium, a magneto-optical recording medium, or a semiconductor recording medium. Each of the wireless devices reads the programs from a recording medium, so as to perform the above described control operations. Alternatively, the wireless devices may read such programs from an external device connected to the wireless devices over a predetermined network, so as to perform the control operations.

A wireless station, a wireless communication system, a wireless communication control method, and a computer-readable medium having a wireless communication control program in accordance with the present invention can be implemented in a wireless communication system for voice communications that require highly sophisticated wireless communication techniques. Since communications between wireless access points can be performed, a wireless station, a wireless communication system, a wireless communication control method, and a computer-readable medium having a wireless communication control program in accordance can be implemented in a wireless communication system having a high-speed handover function that requires direct communications between wireless access points.

An exemplary advantage according to the invention is that a wireless station controls a wireless device that is an interference source, and radio interference between the wireless access point and the wireless device can be prevented, even where the wireless access point cannot recognize the existence of the wireless device that is an interference source to cause radio interference with a radio wave from the wireless access point.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A wireless station that is associated with a wireless access point and performs wireless communications with the wireless access point, comprising:
an interference source detecting unit that detects a wireless device to be an interference source that causes radio interference with a radio wave from the wireless access point; and
a control signal transmitting unit that transmits a control signal for preventing radio interference to the wireless device to be an interference source.

2. The wireless station according to claim 1, further comprising
a control signal receiving unit that receives the control signal from the wireless access point,
wherein the control signal transmitting unit transmits the control signal received through the control signal receiving unit.

3. The wireless station according to claim 2, wherein the control signal transmitting unit transmits the control signal, when the control signal received through the control signal receiving unit is a control signal directed to the wireless station.

4. The wireless station according to claim 1, wherein the interference source detecting unit includes an interference source determining unit that determines whether a neighbor wireless device located in the vicinity of the wireless station is the wireless device to be an interference source, based on a first received signal strength received from the wireless access point and a second received signal strength received from the neighbor wireless device.

5. The wireless station according to claim 4, wherein the interference source determining unit determines whether the neighbor wireless device is the wireless device to be an interference source, based on a received signal strength ratio between the first received signal strength and the second received signal strength.

6. The wireless station according to claim 5, wherein the interference source determining unit determines that the neighbor wireless device is the wireless device to be an interference source, when the received signal strength ratio is lower than a predetermined threshold value.

7. The wireless station according to claim 1, further comprising
an interference source managing unit that manages device information as to the wireless device to be an interference source,
wherein the control signal transmitting unit transmits the control signal to the wireless device, based on the device information managed by the interference source managing unit.

8. The wireless station according to claim 7, wherein:
when the interference source determining unit determines that the neighbor wireless device is the wireless device to be an interference source, the device information as to the neighbor wireless device is registered or updated in the interference source managing unit; and
when the interference source determining unit determines that the neighbor wireless device is not the wireless device to be an interference source, the device information as to the neighbor wireless device is deleted from the interference source managing unit.

9. The wireless station according to claim 7, wherein:
the interference source managing unit manages the device information and related information for identifying the wireless device to which the control signal is to be transmitted on a unicast; and
the control signal transmitting unit transmits the control signal on a unicast to the wireless device identified based on the related information.

10. The wireless station according to claim 7, wherein:
the interference source managing unit manages the device information and related information that includes at least one of a total number of times the interference source determining unit determines a subject wireless device is the wireless device, a total amount of received data of the wireless device, and a latest received signal strength received from the wireless device; and
the control signal transmitting unit identifies the wireless device to which the control signal is to be transmitted on a unicast, based on the related information, and transmits the control signal on a unicast to the identified wireless device.

11. The wireless station according to claim 10, wherein the control signal transmitting unit identifies the wireless device to which the control signal is to be transmitted on a unicast, when the total number of times is equal to or larger than a predetermined threshold value, the total amount of received data is equal to or larger than a predetermined threshold value, or the latest received signal strength is smaller than a predetermined threshold value.

12. The wireless station according to claim 9, wherein:
when the interference source determining unit determines that the neighbor wireless device is the wireless device to be an interference source, the device information as to the neighbor wireless device is registered or updated in the interference source managing unit, and, when the interference source determining unit determines that a total number of times the neighbor wireless device is determined to be the wireless device is equal to or larger than a predetermined threshold value, or that a total amount of received data of the wireless device is equal to or larger than a predetermined threshold value, or that a received signal strength received from the wireless device is smaller than a predetermined threshold value, the related information for identifying the wireless device to which the control signal is to be transmitted on a unicast is registered or updated in the interference source managing unit; and
when the interference source determining unit determines that the neighbor wireless device is not the wireless device to be an interference source, the device information as to the neighbor wireless device is deleted from the interference source managing unit.

13. The wireless station according to claim 7, wherein:
the interference source managing unit manages the device information and last update time indicating a time at which the device information is registered or updated in the interference source managing unit; and
when the last update time is not updated over a predetermined period of time, the interference source managing unit deletes the device information from the interference source managing unit.

14. The wireless station according to claim 1, wherein:
the control signal includes period information; and
the control signal transmitting unit transmits the control signal including the period information, so as to cause the wireless device to perform control to prevent the radio interference in a period of time represented by the period information.

15. A wireless communication system comprising a wireless access point and a wireless station that is associated with the wireless access point and performs a wireless communication,
the wireless station comprising:
an interference source detecting unit that detects a wireless device to be an interference source that causes radio interference with a radio wave from the wireless access point; and
a control signal transmitting unit that transmits a control signal for preventing radio interference to the wireless device to be an interference source.

16. The wireless communication system according to claim 15, wherein:
the wireless access point includes a control signal transmitting unit that transmits the control signal to a wireless station;
the wireless station includes a control signal receiving unit that receives the control signal from the wireless access point; and
the control signal transmitting unit transmits the control signal received through the control signal receiving unit.

17. The wireless communication system according to claim 16, wherein the control signal transmitting unit transmits the control signal, when the control signal received through the control signal receiving unit is a control signal directed to the wireless station.

18. The wireless communication system according to claim 15, wherein the interference source detecting unit includes an interference source determining unit that determines whether a neighbor wireless device located in the vicinity of the wireless station is the wireless device to be an interference source, based on a first received signal strength received from the wireless access point and a second received signal strength received from the neighbor wireless device.

19. The wireless communication system according to claim 18, wherein the interference source determining unit determines whether the neighbor wireless device is the wireless device to be an interference source, based on a received signal strength ratio between the first received signal strength and the second received signal strength.

20. The wireless communication system according to claim 19, wherein the interference source determining unit determines that the neighbor wireless device is the wireless device to be an interference source, when the received signal strength ratio is lower than a predetermined threshold value.

21. The wireless communication system according to claim 15, wherein:
the wireless station further includes an interference source managing unit that manages device information as to the wireless device to be an interference source; and
the control signal transmitting unit transmits the control signal to the wireless device, based on the device information managed by the interference source managing unit.

22. The wireless communication system according to claim 21, wherein:
when the interference source determining unit determines that the neighbor wireless device is the wireless device to be an interference source, the device information as to the neighbor wireless device is registered or updated in the interference source managing unit; and
when the interference source determining unit determines that the neighbor wireless device is not the wireless device to be an interference source, the device information as to the neighbor wireless device is deleted from the interference source managing unit.

23. The wireless communication system according to claim 21, wherein:
the interference source managing unit manages the device information and related information for identifying the wireless device to which the control signal is to be transmitted on a unicast; and
the control signal transmitting unit transmits the control signal on a unicast to the wireless device identified based on the related information.

24. The wireless communication system according to claim 21, wherein:
the interference source managing unit manages the device information and related information that includes at least one of a total number of times the interference source determining unit determines a subject wireless device is the wireless device, a total amount of received data of the wireless device, and a latest received signal strength received from the wireless device; and
the control signal transmitting unit identifies the wireless device to which the control signal is to be transmitted on a unicast, based on the related information, and transmits the control signal on a unicast to the identified wireless device.

25. The wireless communication system according to claim 24, wherein the control signal transmitting unit identifies the wireless device to which the control signal is to be transmitted on a unicast, when the total number of times is equal to or larger than a predetermined threshold value, the total amount of received data is equal to or larger than a predetermined threshold value, or the latest received signal strength is smaller than a predetermined threshold value.

26. The wireless communication system according to claim 23, wherein:
when the interference source determining unit determines that the neighbor wireless device is the wireless device to be an interference source, the device information as to the neighbor wireless device is registered or updated in the interference source managing unit, and, when the interference source determining unit determines that a total number of times the neighbor wireless device is determined to be the wireless device is equal to or larger than a predetermined threshold value, or that a total amount of received data of the wireless device is equal to or larger than a predetermined threshold value, or that a received signal strength received from the wireless device is smaller than a predetermined threshold value, the related information for identifying the wireless device to which the control signal is to be transmitted on a unicast is registered or updated in the interference source managing unit; and
when the interference source determining unit determines that the neighbor wireless device is not the wireless device to be an interference source, the device information as to the neighbor wireless device is deleted from the interference source managing unit.

27. The wireless communication system according to claim 21, wherein:
the interference source managing unit manages the device information and last update time indicating a time at which the device information is registered or updated in the interference source managing unit; and
when the last update time is not updated over a predetermined period of time, the interference source managing unit deletes the device information from the interference source managing unit.

28. The wireless communication system according to claim 15, wherein:
the wireless access point transmits the control signal including period information; and
the wireless station transmits the control signal including the period information, so as to cause the wireless device to perform control to prevent the radio interference in a period of time represented by the period information.

29. A wireless communication control method to be utilized in a wireless station that is associated with a wireless access point and performs wireless communications with the wireless access point, wherein the wireless station comprises the steps of:
detecting a wireless device to be an interference source that causes radio interference with a radio wave from the wireless access point; and
transmitting a control signal for preventing radio interference to the wireless device to be an interference source.

30. A computer-readable medium having a wireless communication control program executable at a wireless station that is associated with a wireless access point and performs wireless communications with the wireless access point, for performing:
an interference source detecting operation for detecting a wireless device to be an interference source that causes radio interference with a radio wave from the wireless access point; and
a control signal transmitting operation for transmitting a control signal to the wireless device to be an interference source, the control signal being for preventing radio interference.

31. A wireless station that is associated with a wireless access point and performs wireless communications with the wireless access point, comprising:
means for detecting a wireless device to be an interference source that causes radio interference with a radio wave from the wireless access point; and
means for trasmitting a control signal for preventing radio interference to the wireless device to be an interference source.

32. A wireless communication system comprising a wireless access point and a wireless station that is associated with the wireless access point and performs a wireless communication,
the wireless station comprising:
means for detecting a wireless device to be an interference source that causes radio interference with a radio wave from the wireless access point; and
means for transmitting a control signal for preventing radio interference to the wireless device to be an interference source.
